(19) United States
(12) Patent Application Publication
(10) Pub. No.: US 2026/0126691 A1
(43) Pub. Date: May 7, 2026

(54) DISPLAY PANEL AND ARRAY SUBSTRATE THEREOF

(71) Applicant: HANNSTAR DISPLAY CORPORATION, Taipei City (TW)

(72) Inventors: Yu-Chi CHIAO, Taipei City (TW); I-Tung CHEN, Taipei City (TW); Jhih Jie HUANG, Taipei City (TW); Shih Chung LO, Taipei City (TW); Chiung-Chang WU, Taipei City (TW)

(73) Assignee: HANNSTAR DISPLAY CORPORATION, Taipei City (TW)

(21) Appl. No.: 19/322,766

(22) Filed: Sep. 9, 2025

(30) Foreign Application Priority Data
Nov. 1, 2024 (TW) 113142022

(51) Int. Cl. G02F 1/1362; G02F 1/1368

(52) U.S. Cl. CPC G02F 1/136227; G02F 1/136222; G02F 1/1368

(57) ABSTRACT

Display panels and array substrates thereof are disclosed, which comprise a substrate and a plurality of pixel units, wherein the substrate has two surfaces that are parallel and opposite to each other, the plurality of pixel units are disposed on the substrate, and at least one of the plurality of pixel units comprises an active element, a reflective structure, and an insulation structure, wherein the reflective structure has a reflective layer and a pixel electrode overlapping with each other and is adjacent to one of the two surfaces of the substrate, the insulation structure is disposed around the active element and has at least one conductive hole, and the active element and the pixel electrode are electrically connected to each other through the at least one conductive hole. This way, the impact of the manufacturing process on the production quality of the reflective layer can be effectively reduced.

### CROSS REFERENCE TO RELATED APPLICATIONS

This application claims the priority of Taiwan Patent Applications No. 113142022, titled “DISPLAY PANEL AND ARRAY SUBSTRATE THEREOF,” filed on Nov. 1, 2024, the disclosures of which are incorporated herein by reference.

### FIELD OF THE INVENTION

The present disclosure relates to a display device, specifically to display panels and array substrates thereof, suitable for a reflective display.

### BACKGROUND OF THE INVENTION

Liquid crystal panels (LCD panels) can be roughly divided into transmissive type LCD panels, reflective type LCD panels, and transflective type LCD panels. Among them, the reflective type liquid crystal panel has a reflective layer that reflects incident ambient light to display the image. In addition to having high reflectivity in the visible spectrum range, the reflective layer's surface needs to be planarized and smooth to maintain the stability and reliability of the light reflection process.

Although there have been some related technologies in the past, such as improving the planarization and smoothness of the reflective layer, if the mutual interference caused by adjacent film layers during the manufacturing process is not considered, it will still affect the manufacturing quality and needs to be improved.

Given the above, it is necessary to provide a technical solution different from the prior art to solve the problems existing in conventional technology.

### SUMMARY OF THE INVENTION

The object of the present disclosure is to provide a display panel and an array substrate thereof to effectively reduce the influence of the manufacturing process on the manufacturing quality of a reflective layer.

To achieve the purpose mentioned above, one aspect of the present disclosure provides an array substrate, which includes: a substrate having two surfaces parallel to each other; and a plurality of pixel units disposed on the substrate, at least one of the plurality of pixel units comprising: an active element; a reflective structure having a reflective layer and a pixel electrode disposed in a stacked manner, wherein the reflective structure is disposed adjacent to one of the two surfaces of the substrate; and an insulation structure disposed around the active element, wherein the insulation structure has at least one conductive hole, and the active element and the pixel electrode are electrically connected through the at least one conductive hole.

In some embodiments of the present disclosure, the pixel electrode is disposed on one side of the reflective layer facing the active element.

In some embodiments of the present disclosure, the active element comprises a semiconductor layer, a gate, a source, and a drain, wherein the semiconductor layer and the gate are stacked and insulated from each other, the source is electrically connected to the semiconductor layer, and the drain is electrically connected to the semiconductor layer and the pixel electrode.

In some embodiments of the present disclosure, the active element comprises a semiconductor layer, a gate, a source, and a drain, the semiconductor layer and the gate are stacked and insulated from each other, the semiconductor layer is electrically connected to the source and the drain, wherein the drain is electrically connected to the pixel electrode, and the drain and the reflective layer are arranged in a same layer.

In some embodiments of the present disclosure, the semiconductor layer comprises indium gallium zinc oxide (IGZO) or low-temperature polycrystalline silicon (LTPS).

In some embodiments of the present disclosure, the active element comprises a metal layer and an amorphous silicon (a-Si) semiconductor stacked and insulated from each other, the metal layer comprises a gate and the reflective layer insulated from each other, the gate and the amorphous silicon semiconductor overlap within a projection range of the substrate, a source and a drain disposed on two opposite sides of the amorphous silicon semiconductor, the source and the drain are electrically connected to the amorphous silicon semiconductor, and the drain is electrically connected to the pixel electrode.

In some embodiments of the present disclosure, the reflective layer is disposed on one side of the substrate away from the active element, the substrate has a through hole, the through hole is in communication with the at least one conductive hole, and the active element and the pixel electrode are electrically connected through the at least one conductive hole and the through hole.

In some embodiments of the present disclosure, the active element comprises a semiconductor layer and a gate, a source, and a drain are disposed on two opposite sides of the semiconductor layer, the source and the drain are electrically connected to the semiconductor layer, and the gate and the semiconductor layer are within the projection range of the substrate.

In some embodiments of the present disclosure, a buffer layer is disposed between the reflective structure and the substrate.

In some embodiments of the present disclosure, the buffer layer comprises at least two stacked buffer films.

In some embodiments of the present disclosure, a protective layer is disposed on one side of the reflective structure away from the substrate.

In some embodiments of the present disclosure, the protective layer comprises a light-transmitting material comprising a silicon-based compound, aluminum oxide (AlₓO_{y}), or a combination thereof, wherein the silicon-based compound comprises one of silicon oxide (SiOₓ), silicon nitride (SiNₓ), or silicon oxynitride (SiOₓN_{y}).

In some embodiments of the present disclosure, the buffer layer comprises a conductive material comprising indium tin oxide (ITO), indium zinc oxide (IZO), molybdenum (Mo), aluminum (Al), titanium (Ti), molybdenum oxide (MoOₓ), aluminum oxide (AlOₓ), titanium oxide (TiOₓ), molybdenum aluminide (MoAl), or a combination thereof.

In some embodiments of the present disclosure, the reflective layer comprises a metal material, and the metal material comprises one of silver or aluminum.

In some embodiments of the present disclosure, a thickness of the reflective layer is greater than 900 angstroms (Å).

In some embodiments of the present disclosure, the thickness of the reflective layer ranges from 900 angstroms to 1200 angstroms.

In some embodiments of the present disclosure, one side of the reflective layer has surface microstructures.

In some embodiments of the present disclosure, the insulation structure comprises a plurality of insulation material layers disposed in a stacked manner, and the plurality of insulation material layers comprises inorganic materials comprising silicon oxide (SiO₂), silicon nitride (SiNₓ), silicon oxynitride (SiOₓN_{y}), or a combination thereof.

To achieve the purpose mentioned above, one aspect of the present disclosure provides a display panel, comprising: an array substrate; a color filter substrate disposed opposite to the array substrate; and a display medium layer disposed between the array substrate and the color filter substrate; wherein the array substrate comprises a substrate and a plurality of pixel units, wherein the substrate has two surfaces parallel to each other, the plurality of pixel units are disposed on the substrate, and at least one of the plurality of pixel units comprises an active element, a reflective structure, and an insulation structure, the reflective structure has a reflective layer and a pixel electrode disposed in a stacked manner, wherein the reflective structure is disposed adjacent to one of the two surfaces of the substrate, the insulation structure is disposed around the active element, the insulation structure has at least one conductive hole, and the active element and the pixel electrode are electrically connected through the at least one conductive hole.

In some embodiments of the present disclosure, the pixel electrode is disposed on one side of the substrate facing the display medium layer, the active element is disposed on one side of the substrate away from the display medium layer, the substrate has a through hole that is in communication with the at least one conductive hole, and the active element and the pixel electrode are electrically connected through the at least one conductive hole and the through hole.

In the display panel and array substrate thereof of the present disclosure, a plurality of pixel units are disposed on a substrate, at least one of the plurality of pixel units comprises an active element, a reflective structure, and an insulation structure, the reflective structure has a reflective layer and a pixel electrode disposed in a stacked manner and is adjacent to one of the two surfaces of the substrate, the insulation structure is disposed around the active element and has at least one conductive hole, and the active element and the pixel electrode are electrically connected through the at least one conductive hole. Thus, the reflective structure is disposed around the substrate, such that the reflective film is far away from the organic film, thereby effectively reducing the influence of the manufacturing process on the manufacturing quality of the reflective structure.

### BRIEF DESCRIPTION OF THE DRAWINGS

FIG. 1 is a schematic diagram illustrating a structure of a display panel associated with the present disclosure.

FIG. 2 is a schematic diagram illustrating a sputtering process of the display panel of FIG. 1.

FIG. 3 is a schematic diagram illustrating a structure of a display panel associated with the present disclosure.

FIG. 4 is a schematic diagram illustrating a structure of a display panel of a first embodiment of the present disclosure.

FIGS. 5 to 7 are schematic diagrams illustrating structures of active elements of the display panel shown in FIG. 4.

FIGS. 8A to 8D are schematic diagrams illustrating structures between the reflective structure and the substrate of the display panel shown in FIG. 4.

FIG. 9 is a schematic diagram illustrating a display panel associated with the present disclosure.

FIG. 10 is a schematic diagram illustrating a structure of a display panel of a second embodiment of the present disclosure.

FIGS. 11 and 12 are schematic diagrams illustrating structures of active elements of the display panel shown in FIG. 10.

FIGS. 13A to 13D are schematic diagrams illustrating structures between the reflective structure and the substrate of the display panel shown in FIG. 10.

FIG. 14 is a schematic diagram illustrating a structure of a display panel of a third embodiment of the present disclosure.

FIG. 15 is a schematic diagram illustrating a structure of a display panel of a fourth embodiment of the present disclosure.

### THE DETAILED DESCRIPTION OF PREFERRED EMBODIMENTS

It will also be understood that when a layer is referred to as being “on” another layer or substrate, it can be directly on the other layer or substrate (e.g., without any intervening layers therebetween), or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to or different from the described order.

As used herein, expressions such as “at least one of”, “one of”, and “selected from”, when preceding a list of elements, modify the entire list of elements and do not modify the individual elements of the list. For example, “at least one of a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Each of the features of the various embodiments of the present disclosure may be combined or combined with each other, in part or in whole, and technically various interlocking and driving are possible. The embodiments may be implemented independently of each other or may be implemented together in an association.

To make the above and other purposes, features and advantages of the present disclosure more evident and easier to understand, the preferred embodiments of the present disclosure will be specifically cited below and described in detail with reference to the accompanying drawings. Furthermore, directional terms mentioned in the present disclosure, such as up, down, top, bottom, front, back, left, right, inside, outside, side, surrounding, center, horizontal, lateral, vertical, longitudinal, axial, radial, topmost or bottommost, are only for reference to the directions of the attached drawings. Therefore, the directional terms used are adopted to illustrate and understand the present disclosure, rather than to limit the present disclosure.

Hereinafter, embodiments will be described with reference to the accompanying drawings.

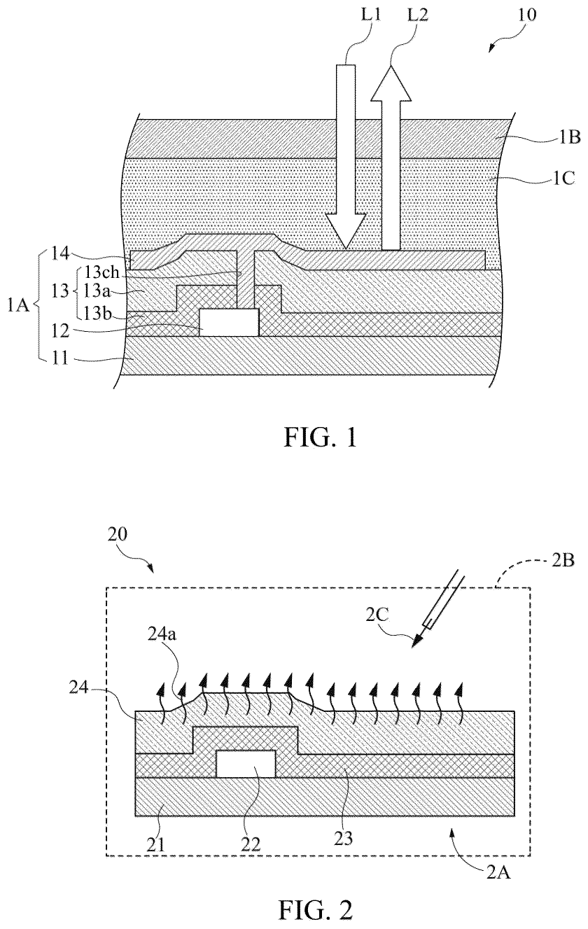

A reflective display panel reflects incident ambient light with a reflective layer. The surface of the reflective layer needs to be planarized and smooth to maintain the stability and reliability of the light reflection process. A related technology uses the OC (overcoat) organic material layer as a planarization layer to make a reflective layer. As shown in FIG. 1, a display panel 10 comprises an array substrate 1A, a color filter substrate 1B, and a display medium layer 1C disposed between them. The array substrate 1A comprises a substrate 11 for disposing a plurality of pixel units. Each pixel unit comprises an active element, such as a thin film transistor. The active element 12 is disposed on the substrate 11, and an insulation structure 13 is disposed over the active element 12. The insulation structure 13 comprises an organic planarization layer 13a and an inorganic insulation layer 13b disposed in a stacked manner. The reflective layer 14 is disposed on the organic planarization layer 13a and is electrically connected to the active element 12 via a conductive hole 13ch to conduct electrical signals and reflect incident light to the external environment (shown as light L1 and L2). In the display panel 10, compared to the inorganic insulation layer 13b, which is affected by the surface morphology of the underlying active element 12, the reflective layer 14, disposed on the organic planarization layer 13a, has higher flatness.

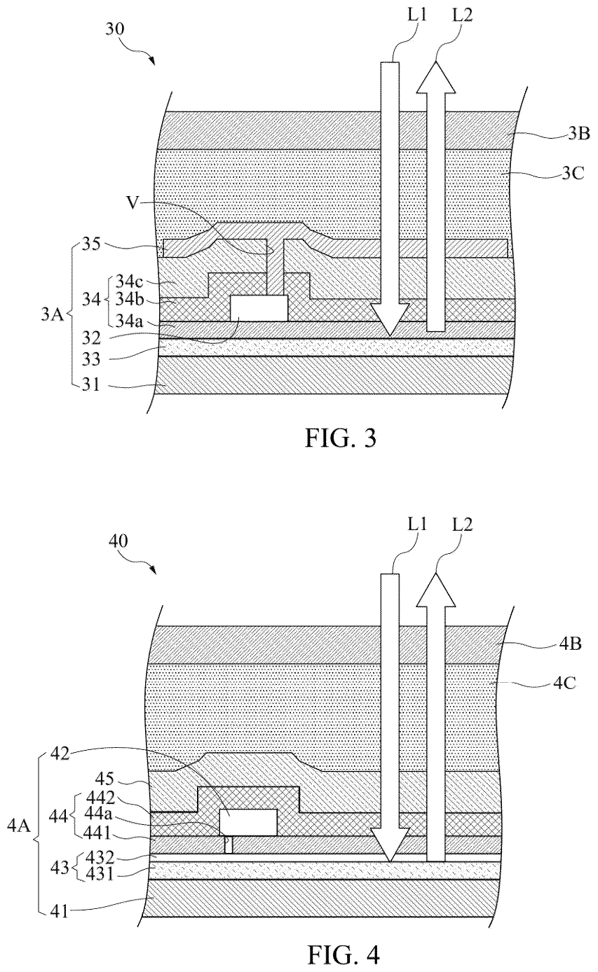

However, FIG. 2 shows a film sputtering environment 20, in which an array substrate 2A comprises a substrate 21, an active element 22, an inorganic insulation layer 23, and an organic planarization layer 24. When a gas 2C is introduced onto the array substrate 2A within a sputtering device 2B to form a reflective film, since the interior of the sputtering device 2B is a heated environment, the organic planarization layer 24 will release a small number of unstable impurities 24a. The impurities 24a mixed with the gas 2C will significantly impact the coating quality of the reflective layer. For example, the reflectivity and color purity will change, and even defects will appear on its surface. Furthermore, it will also be affected by the different water absorption states of the organic planarization layer 24 (comprising OC material) in the previous process, resulting in inconsistencies in state when the reflective film is made, which leads to optical differences.

In the manufacturing process of the reflective film for the reflective display panel, the substrate used to produce the reflective film is an organic film that inevitably releases impurities during a sputtering process of the reflective film, causing variations in the reflective characteristics of the reflective film. The present disclosure provides embodiments of a display panel and an array substrate thereof. It proposes a film structure in which a bottom material of the reflective film is changed. For example, the reflective film is disposed around the substrate, such that the reflective film is away from the organic film, to avoid the impurities released by the organic film affecting a coating result of the reflective film and not affecting the quality of the reflective film made by the vacuum sputtering equipment, to effectively reduce the influence of the process on the production quality of the reflective structure. If the reflective film uses the substrate as a planarization layer, the planarization in this design is better than that in the organic planarization layer, resulting in products with better liquid crystal cell gap control capability and a wider margin for controlling the reflected light angle.

Herein, the display panel can be a top-emitting or bottom-emitting configuration. The display panel can replace spliced outdoor billboards and achieves greater splicing efficiency than light-emitting diode (LED) panels, providing a more energy-saving and environmentally friendly option for large billboards. The following are examples, but are not intended to be limited.

For example, many implementation schemes of top-emitting display panels, such as the process of light transmission passing through many material layers around the active element and a reflective structure being located on one side of the substrate facing or away from a display medium, are illustrated as below, but are not intended to be limited.

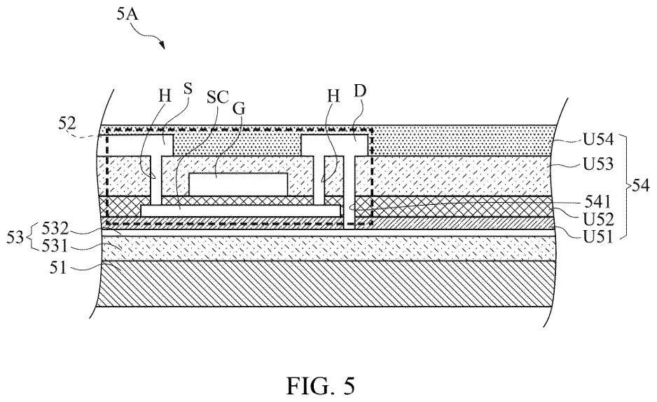

In some embodiments, FIG. 3 illustrates a display panel 30 comprising an array substrate 3A, a color filter substrate 3B, and a display medium layer 3C, wherein the display medium layer 3C is disposed between the array substrate 3A and the color filter substrate 3B. The array substrate 3A comprises a substrate 31. A plurality of pixel units (only a single pixel unit is shown in FIG. 3) are disposed on the substrate 31. At least one of the pixel units comprises an active element 32, a reflective layer 33, an interlayered structure 34, and a transparent electrode 35. The reflective layer 33 is disposed on a surface of the substrate 31 facing the active element 32 to reflect light (shown as L1 and L2). The interlayered structure 34 is disposed around the active element 32. For example, the interlayered structure 34 comprises inorganic insulation layers 34a and 34b, as well as an organic planarization layer 34c. The interlayered structure 34 has a conductive hole V. The active element 32 and the transparent electrode 35 are electrically connected through the conductive hole V. In this embodiment, the transparent electrode 35 is disposed between the reflective layer 33 and the display medium layer 3C.

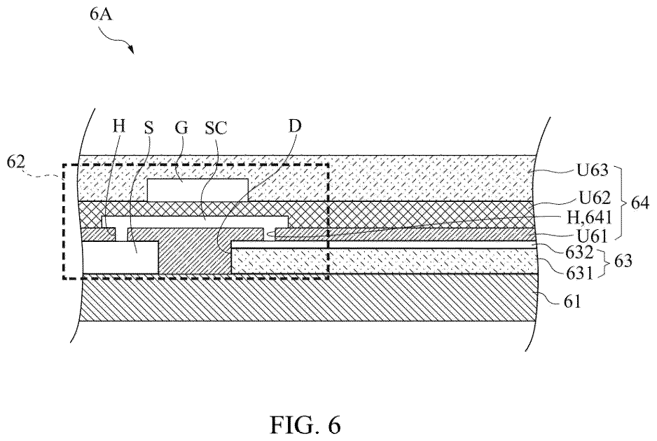

In some embodiments, FIG. 4 illustrates a display panel 40 comprising an array substrate 4A, a color filter substrate 4B, and a display medium layer 4C. The array substrate 4A and the color filter substrate 4B are disposed opposite to each other, and the display medium layer 4C (such as comprising liquid crystal material or electrophoretic material) is disposed between the array substrate 4A and the color filter substrate 4B. The array substrate 4A comprises a substrate 41 (such as a glass substrate) and a plurality of pixel units (FIG. 4 only shows a single pixel unit). The substrate 41 has two parallel surfaces. The plurality of pixel units disposed on the substrate 41. At least one of the pixel units comprises an active element 42, a reflective structure 43, and an insulation structure 44. The active element 42 comprises, but is not limited to, a top-gated or bottom-gated thin film transistor, which contains a semiconductor material, such as amorphous silicon, low-temperature polycrystalline silicon, or metal oxide. The reflective structure 43 has a reflective layer 431 and a pixel electrode 432 that are disposed in a stacked manner. The reflective layer 431 of the reflective structure 43 is adjacent to one side of the substrate 41 (i.e., a light incident side or a reflective side, such as one side of the substrate 41 facing the color filter substrate 4B). For example, the reflective layer 431 comprises a reflective material such as a metal material, comprising one of silver or aluminum. For process and yield considerations, one or more other elements may be doped (such as no more than 10 at %) to avoid affecting the material's original optical properties. The reflective layer 431 is disposed on the side of the substrate 41 facing the active element 42, e.g., the thickness of the reflective layer 431 is greater than 900 angstroms (Å), such as the thickness of the reflective layer 431 ranging from 900 Å to 1200 Å, for reflecting light (as shown by L1 and L2). In addition, the reflective layer 431 may also have surface microstructures, for example, located on the side of the reflective layer 431 facing the active element 42 (i.e., the light-incident side), which helps improve the light reflection effect. The pixel electrode 432, for example, is a transparent conductive film and disposed on one side of the reflective layer 431, facing the active element 42, so that the pixel electrode 432 is electrically connected to the active element 42. The insulation structure 44 is disposed around the active element 42. The insulation structure 44 has at least one conductive hole 44a, through which the active element 42 and the pixel electrode 432 are electrically connected.

In this embodiment, as shown in FIG. 4, the insulation structure 44 may include a plurality of stacked insulation material layers, wherein the insulation material layers contain inorganic materials. The inorganic materials include silicon oxide (SiO₂), silicon nitride (SiNₓ), silicon oxynitride (SiOₓN_{y}), or a combination thereof. For example, the insulation structure 44 comprises two inorganic material layers 441 and 442. The inorganic material layer (e.g., an inorganic insulation layer) 441 is disposed on the reflective structure 43. The active element 42 is disposed on the inorganic material layer 441. The inorganic material layer 441 has the conductive hole 44a for electrically connecting the active element 42 with the pixel electrode 432. The inorganic material layer (e.g., an inorganic insulation layer) 442 covers the inorganic material layer 441 and the active element 42. The array substrate 4A may also include an organic material layer (which may serve as a planarization layer) 45, e.g., made of a resin material such as acrylic. The organic material layer 45 covers the inorganic material layer 442 for disposing of the display medium layer 4C.

In this embodiment, the reflective structure has a reflective layer and a pixel electrode to provide functions of light reflection and driving the display medium. A plurality of reflective structures must be independently disposed, corresponding to the pixels. Namely, the reflective structures corresponding to different pixels are not integrated. By the conductive hole between the reflective structure and the active element, the pixel electrode of each reflective structure can be used to control a corresponding pixel. Compared to the light conduction process of the display panel, in which light must pass through the transparent electrode between the organic planarization layer and the display medium layer (such as “35” shown in FIG. 3), this embodiment can reduce light transmission leakage and improve the light reflection effect. The structure of the active element of the display panel provided in this embodiment is described as follows by way of example, but is not limited thereto.

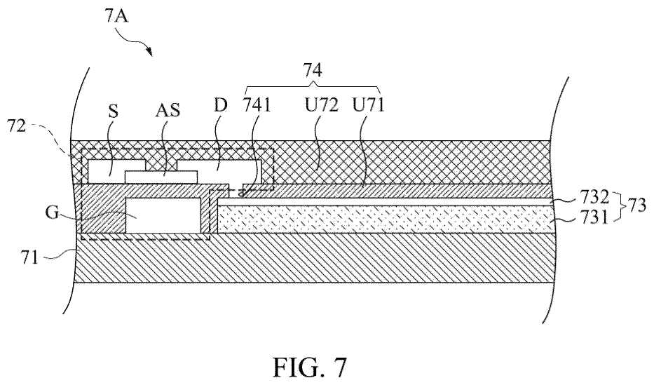

Optionally, in some embodiments, FIG. 5 illustrates an array substrate 5A, which comprises a substrate 51 and a plurality of pixel units (FIG. 5 only shows a single pixel unit). The substrate 51 has two parallel surfaces. The plurality of pixel units disposed on the substrate 51. At least one of the pixel units comprises an active element 52, a reflective structure 53, and an insulation structure 54. The reflective structure 53 has a reflective layer 531 and a pixel electrode 532 that are disposed in a stacked manner. The reflective structure 53 is adjacent to the substrate 51. For example, the reflective layer 531 is disposed on the substrate 51 to reflect light (such as L1 and L2 shown in FIG. 4). The pixel electrode 532 is disposed on one side of the reflective layer 531 facing the active element 52. The insulation structure 54 is disposed around the active element 52. The insulation structure 54 has at least one conductive hole 541, through which the active element 52 and the pixel electrode 532 are electrically connected.

In this embodiment, as shown in FIG. 5, the active element 52 comprises a semiconductor layer SC (such as low-temperature polycrystalline silicon (LTPS) or indium gallium zinc oxide (IGZO)), a gate (such as a conductive material) G, a source (such as a conductive material) S and a drain (such as a conductive material) D. The semiconductor layer SC and the gate G are stacked and insulated from each other. The source S is electrically connected to the semiconductor layer SC via a through hole H. The drain D is electrically connected to the semiconductor layer SC via the other through hole H and is electrically connected to the pixel electrode 532 through a conductive hole 541.

In this embodiment, as shown in FIG. 5, the insulation structure 54 comprises four inorganic material layers (e.g., inorganic insulation layers) U51, U52, U53, and U54. The inorganic material layer U51 is disposed on the pixel electrode 532. The oxide semiconductor SC is disposed on the inorganic material layer U51. For example, the inorganic material layer U51 partially serves as an interlayered-insulation layer between the pixel electrode 532 and the oxide semiconductor SC. The inorganic material layer U52 covers the oxide semiconductor SC and the inorganic material layer U51. The gate G is disposed on the inorganic material layer U52. For example, the inorganic material layer U52 partially serves as an interlayered-insulation layer between the oxide semiconductor SC and the gate G. The material layer U53 covers the gate G and the inorganic material layer U52, and the source S and the drain D are arranged in the inorganic material layer U53. For example, the inorganic material layer U53 partially serves as an interlayered-insulation layer between the gate G and the source S and the drain D. Each of the conductive material of the source S and the conductive material of the drain D passes through the inorganic material layers U53 and U52 via the through hole H and extend to the oxide semiconductor SC. The conductive material of the drain D also passes through the inorganic material layers U53, U52, and U51 through the conductive hole 541 to extend to the pixel electrode 532. The inorganic material layer U54 covers the source S, the drain D, and the inorganic material layer U53. For example, the inorganic material layer U54 serves as a planarization layer.

Alternatively, in some embodiments, FIG. 6 illustrates an array substrate 6A comprising a substrate 61 and a plurality of pixel units (FIG. 6 only shows a single pixel unit). The substrate 61 has two parallel surfaces. The plurality of pixel units is disposed on the substrate 61. At least one of the pixel units comprises an active element 62, a reflective structure 63, and an insulation structure 64. The reflective structure 63 has a reflective layer 631 and a pixel electrode 632 that are disposed in a stacked manner. The reflective structure 63 is adjacent to the substrate 61, for example, the reflective layer 631 is disposed on the substrate 61 to reflect light (such as L1 and L2 shown in FIG. 4). The pixel electrode 632 is disposed on one side of the reflective layer 631 facing the active element 62. The insulation structure 64 is disposed around the active element 62. The insulation structure 64 has at least one conductive hole 641. The active element 62 and the pixel electrode 632 are electrically connected through at least one conductive hole 641.

In this embodiment, FIG. 6 illustrates the active element 62 comprising a semiconductor layer SC (such as low-temperature polycrystalline silicon (LTPS) or indium gallium zinc oxide (IGZO)), a gate (such as a conductive material) G, a source (such as a conductive material) S, and a drain (such as a conductive material) D. The semiconductor layer SC and the gate G are stacked and insulated from each other. The semiconductor layer SC is electrically connected to the source S and the drain D through two through holes H. For example, the semiconductor layer SC is electrically connected to the pixel electrode 632 via the through hole H, the pixel electrode 632 is electrically connected to the drain D, and the drain D and the reflective layer 631 are arranged in the same layer. In this embodiment, a light-shielding member (not shown) may be placed under the semiconductor layer SC to make photoelectric signals more stable.

In this embodiment, as shown in FIG. 6, the insulation structure 64 comprises three inorganic material layers (e.g., inorganic insulation layers) U61, U62, and U63. The inorganic material layer U61 covers the reflective structure 63, the drain D, and the source S. The semiconductor layer SC is disposed on the inorganic material layer U61, for example, the inorganic material layer U61 partially serves as an interlayered-insulation layer between the semiconductor layer SC and each of the reflective structure 63, the drain D, and the source S. The inorganic material layer U62 covers the semiconductor layer SC and the inorganic material layer U61. The gate G is disposed on the inorganic material layer U62, for example, the inorganic material layer U62 partially serves as an interlayered-insulation layer between the semiconductor layer SC and the gate G. The inorganic material layer U63 covers the gate G and the inorganic material layer U62, for example, the inorganic material layer U63 serves as a planarization layer. The material of the semiconductor layer SC passes through the inorganic material layer U61 via the through hole H to extend to the source S. The material of the semiconductor layer SC passes through the inorganic material layer U61 via the through hole H and the conductive hole 641 to extend to the drain D and the pixel electrode 632.

Alternatively, in some embodiments, FIG. 7 illustrates an array substrate 7A comprising a substrate 71 and a plurality of pixel units (FIG. 7 only shows a single pixel unit). The substrate 71 has two parallel surfaces. The plurality of pixel units are disposed on the substrate 71. At least one of the pixel units comprises an active element 72, a reflective structure 73, and an insulation structure 74. The reflective structure 73 has a reflective layer 731 and a pixel electrode 732 that are disposed in a stacked manner. The reflective structure 73 is adjacent to the substrate 71, for example, the reflective layer 731 is disposed on the substrate 71 to reflect light (such as L1 and L2 shown in FIG. 4), and the pixel electrode 732 is disposed on one side of the reflective layer 731 facing the active element 72. The insulation structure 74 is disposed around the active element 72. The insulation structure 74 has at least one conductive hole 741. The active element 72 and the pixel electrode 732 are electrically connected through at least one conductive hole 741.

In this embodiment, as shown in FIG. 7, the active element 72 comprises a metal layer and an amorphous silicon (a-Si) semiconductor AS that are stacked and insulated from each other. The metal layer comprises a gate G and a reflective layer 731 that are insulated from each other. The gate G and the amorphous silicon semiconductor AS overlap within a projection range of the substrate 71. For example, the gate G is located between the substrate 71 and the amorphous silicon semiconductor AS. A source S and a drain D are disposed on two opposite sides of the amorphous silicon semiconductor AS. The source S and the drain D are electrically connected to the amorphous silicon semiconductor AS, and the drain D is electrically connected to the pixel electrode 732 through a conductive hole 741.

In this embodiment, as shown in FIG. 7, the insulation structure 74 comprises two inorganic material layers (for example, serving as inorganic insulation layers) U71 and U72. The inorganic material layer U71 covers the substrate 71, the reflective structure 73, and the gate G. The amorphous silicon semiconductor AS is disposed on the inorganic material layer U71. For example, the inorganic material layer U71 partially serves as an interlayered-insulation layer between the amorphous silicon semiconductor AS, the reflective structure 73, and the gate G. The inorganic material layer U72 covers the amorphous silicon semiconductor AS, the source S, and the drain D. For example, the inorganic material layer U72 serves as a planarization layer. The conductive material of the drain D passes through the inorganic material layer U71 through the conductive hole 741 to extend to the pixel electrode 732.

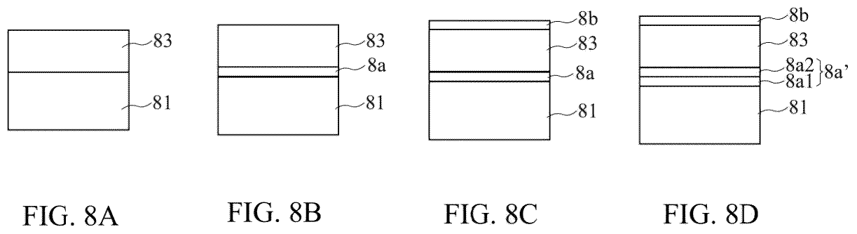

In some embodiments, for example, the reflective structure is located between the active element and the substrate, and a configuration between the reflective structure and the substrate can be fine-tuned. For example, as shown in FIG. 8A, a reflective structure 83 may be provided on the substrate 81. In addition, as shown in FIG. 8B, a buffer layer 8a may be provided between the substrate 81 and the reflective structure 83. The buffer layer 8a may be made of a light-transmitting or opaque material, for example, the buffer layer 8a comprises a conductive material. The conductive material comprises indium tin oxide (ITO), indium zinc oxide (IZO), molybdenum (Mo), aluminum (Al), titanium (Ti), molybdenum oxide (MoOₓ), aluminum oxide (AlOₓ), titanium oxide (TiOₓ), molybdenum aluminide (MoAl), or a combination thereof. In addition, as shown in FIG. 8C, a buffer layer 8a is disposed between the substrate 81 and the reflective structure 83, and a protective layer 8b is disposed on one side of the reflective structure 83 away from the substrate 81. The protective layer 8b can be made of a highly light-transmitting material, which can be a conductor or a non-conductor, such as a silicon-based compound, aluminum oxide (AlₓO_{y}), or a combination thereof, wherein the silicon-based compound comprises one of silicon oxide (SiOₓ), silicon nitride (SiNₓ), or silicon oxynitride (SiOₓN_{y}). In addition, as shown in FIG. 8D, a buffer layer 8a′ is disposed between the substrate 81 and the reflective structure 83. A protective layer 8b is disposed on one side of the reflective structure 83 away from the substrate 81, wherein the buffer layer 8a′ comprises at least two buffer films (such as 8a1 and 8a2) disposed in a stacked manner. The buffer films can be made of the same material as the above-mentioned buffer layer, which will not be repeated.

For example, in addition to configurations in which the reflective structures are located between the active element and the substrate, the implementations of a top-emitting display panel may also include configurations in which the substrate is located between the active element and the reflective structure, as illustrated below, but not limited thereto.

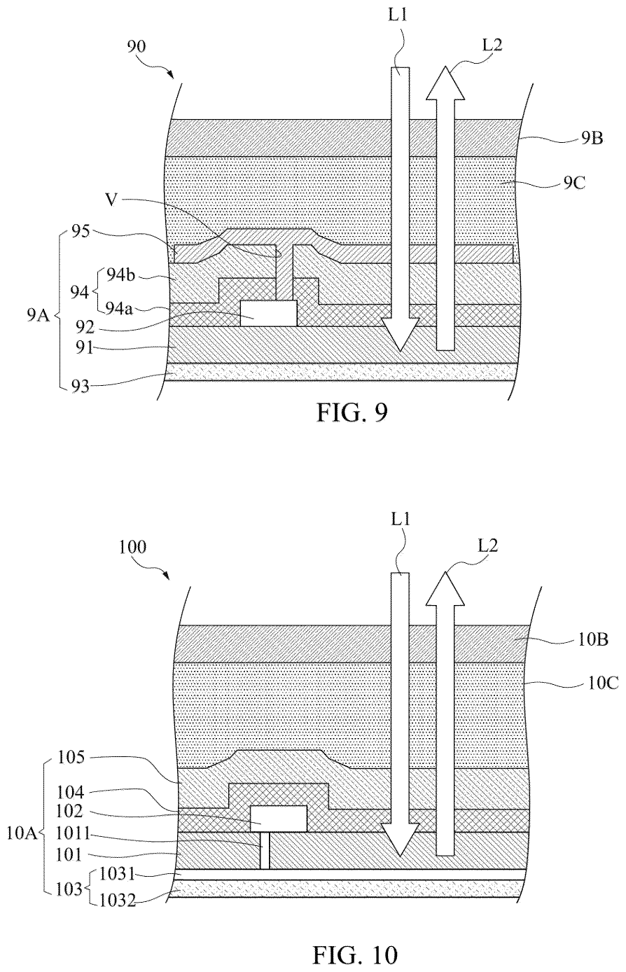

In some embodiments, as shown in FIG. 9, a display panel 90 comprises an array substrate 9A, a color filter substrate 9B, and a display medium layer 9C. The display medium layer 9C is disposed between the array substrate 9A and the color filter substrate 9B. The array substrate 9A comprises a substrate 91. A plurality of pixel units (only a single pixel unit shown in FIG. 9) disposed on the substrate 91. At least one of the pixel units comprise an active element 92, a reflective layer 93, an interlayered structure 94, and a transparent electrode 95. The reflective layer 93 is disposed on a surface of the substrate 91 away from the active element 92 to reflect light (as shown by L1 and L2). The interlayered structure 94 is disposed around the active element 92. For example, the interlayered structure 94 comprises an inorganic insulation layer 94a and an organic planarization layer 94b. The interlayered structure 94 has a conductive hole V. The active element 92 and the transparent electrode 95 are electrically connected through the conductive hole V. In this embodiment, the transparent electrode 95 is between the reflective layer 93 and the display medium layer 9C. All light incident and reflected (such as L1 and L2) processes pass through the transparent electrode 95, so the light transmission effect is affected by the light transmittance of the transparent electrode 95.

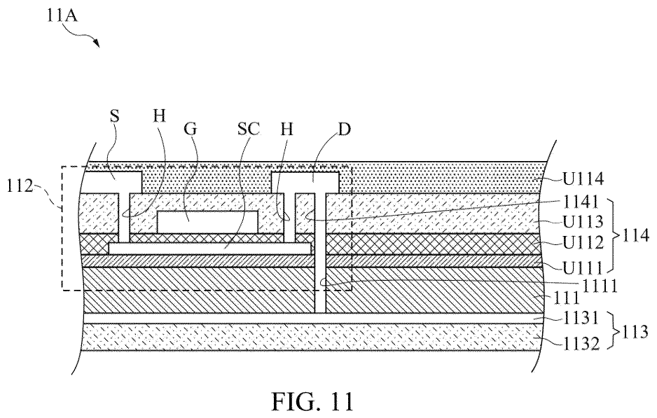

In some embodiments, as shown in FIG. 10, a display panel 100 comprises an array substrate 10A, a color filter substrate 10B, and a display medium layer 10C. The array substrate 10A and the color filter substrate 10B are disposed opposite to each other. The display medium layer 10C (such as comprising liquid crystal material or electrophoretic material) is disposed between the array substrate 10A and the color filter substrate 10B. The array substrate 10A comprises a substrate 101 (such as a glass substrate) and a plurality of pixel units (only a single pixel unit shown in FIG. 10). The substrate 101 has two surfaces that are parallel to each other. The plurality of pixel units are disposed on the substrate 101. At least one of the pixel units comprises an active element 102, a reflective structure 103, and an insulation structure 104. The reflective structure 103 is disposed on a side of the substrate 101 away from the active element 102 (i.e., the light incident side or the light reflecting side). For example, the reflective structure 103 has a pixel electrode 1031 and a reflective layer 1032 disposed in a stacked manner. The pixel electrode 1031 of the reflective structure 103 is adjacent to the substrate 101. The substrate 101 has a through hole 1011 through which the pixel electrode 1031 is electrically connected to the active element 102. The reflective layer 1032 comprises a metal material, comprising but not limited to silver or aluminum. However, for process and yield considerations, one or more other elements may be doped(such as not more than 10 at %), so as not to affect the original optical properties of the material. The reflective layer 1032 is arranged on a side of the substrate 101 away from the active element 102. For example, the thickness of the reflective layer 1032 is greater than 900 angstroms (Å), such as the thickness of the reflective layer 1032 ranges from 900 angstroms to 1200 angstroms, for reflecting light (as shown by L1 and L2). The reflective layer 1032 may also have surface microstructures. The surface microstructure is located on the side of the reflective layer 1032 facing the active element 1021 (i.e., the light incident side) to improve the light reflection effect. The insulation structure 104 is disposed around the active element 102. The insulation structure 104 may have at least one conductive hole (not shown). For example, at least one conductive hole communicates with the through hole 1011 of the substrate 101, and the active element 102 and the pixel electrode 1031 are electrically connected through the at least one conductive hole and the through hole 1011.

In this embodiment, as shown in FIG. 10, the insulation structure 104 may include at least one insulation material layer which comprises an inorganic material, and the inorganic material comprises silicon oxide (SiO₂), silicon nitride (SiNₓ), silicon oxynitride (SiOₓN_{y}), or a combination thereof. For example, the active element 102 is disposed on the substrate 101, and the insulation structure 104 comprises an inorganic material layer (e.g., as an insulation layer) covering the active element 102 and the substrate 101. The array substrate 10A may also include an organic material layer (e.g., as a planarization layer) 105, e.g., made of a resin material such as acrylic. The organic material layer 105 covers the insulation structure 104 and can be used to dispose the display medium layer 10C.

In this embodiment, the reflective structure has a reflective layer and a pixel electrode to provide functions of light reflection and driving the display medium. A plurality of reflective structures must be independently disposed, corresponding to a plurality of pixels. Namely, the reflective structures corresponding to different pixels are not integrated. Using the conductive holes between the reflective structure and the active element and the through holes of the substrate, the pixel electrode of each reflective structure can be used to control a respective one of the pixels. Compared with the light transmission process in a display panel that must pass through the transparent electrode (such as 95 in FIG. 9) between the organic planarization layer and the display medium layer, this embodiment in the present disclosure can reduce the leakage of light transmission and improve the light reflection effect. In addition, in this embodiment, a light reflection interface is located between the substrate and the reflective layer to have an excellent and stable reflectivity. The structure of the active element of the display panel of this embodiment is described as follows by way of example, but is not limited thereto.

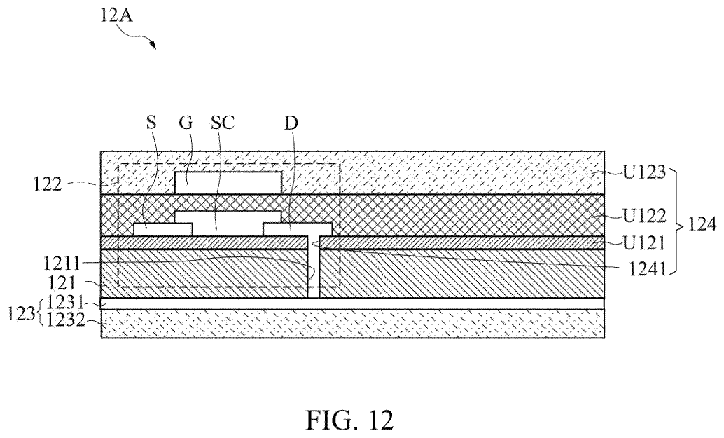

Optionally, in some embodiments, as shown in FIG. 11, an array substrate 11A comprises a substrate 111 and a plurality of pixel units (only a single pixel unit shown in FIG. 11). The substrate 111 has two surfaces parallel to each other. The plurality of pixel units disposed on the substrate 111. At least one of the pixel units comprises an active element 112, a reflective structure 113, and an insulation structure 114. The reflective structure 113 has a pixel electrode 1131 (such as a transparent electrode) and a reflective layer 1132 that are disposed in a stacked manner. The reflective structure 113 is disposed adjacent to the substrate 111. For example, the pixel electrode 1131 is disposed between the substrate 111 and the reflective layer 1132. The pixel electrode 1131 is located on a side of the reflective layer 1132 facing the active element 112. The reflective layer 1132 is used to reflect light (such as L1 and L2 shown in FIG. 10). The insulation structure 114 is disposed around the active element 112. The insulation structure 114 has a conductive hole 1141. The conductive hole 1141 communicates with the through hole 1111 of the substrate 111. The active element 112 and the pixel electrode 1131 are electrically connected through the conductive hole 1141 and the through hole 1111.

In this embodiment, as shown in FIG. 11, the active element 112 comprises a semiconductor layer SC (such as low-temperature polycrystalline silicon (LTPS) or indium gallium zinc oxide (IGZO)), a gate (such as a conductive material) G, a source (such as a conductive material) S, and a drain (such as a conductive material) D. The source S is electrically connected to the semiconductor layer SC via a through hole H. The drain D is electrically connected to the semiconductor layer SC via the other through hole H and is electrically connected to the pixel electrode 1131 through a conductive hole 1141 and a through hole 1111. For example, the source S and the drain D are electrically connected to the semiconductor layer SC. The drain D and the pixel electrode 1131 are electrically connected through the conductive hole 1141 and the through hole 1111. The gate G and the semiconductor layer SC are disposed within a projection range of the substrate 111.

In this embodiment, as shown in FIG. 11, the insulation structure 114 comprises four inorganic material layers (e.g., being used as inorganic insulation layers) U111, U112, U113, and U114. The inorganic material layer U111 is disposed on the substrate 111. The oxide semiconductor SC is disposed on the inorganic material layer U111, e.g., the inorganic material layer U111 is partially used as an interlayered insulation layer between the substrate 111 and the oxide semiconductor SC. The inorganic material layer U112 covers the oxide semiconductor SC and the inorganic material layer U111. The gate G is disposed on the inorganic material layer U112, e.g., the inorganic material layer U112 is partially used as an interlayered insulation layer between the oxide semiconductor SC and the gate G. The inorganic material layer U113 covers the gate G and the inorganic material layer U112. Each of the source S and the drain D extends to the oxide semiconductor SC through the inorganic material layers U113 and U112 via a through hole H, respectively. The conductive material of the drain D also extends to the pixel electrode 1131, passing through the inorganic material layers U113, U112, and U111 through the conductive hole 1141 and passing through the substrate 111 through the through hole 1111. The inorganic material layer U114 covers the source S, the drain D, and the inorganic material layer U113. For example, the inorganic material layer U114 serves as a planarization layer.

Alternatively, in some embodiments, as shown in FIG. 12, which shows an array substrate 12A, comprising a substrate 121 and a plurality of pixel units (only a single pixel unit is illustrated in FIG. 12). The substrate 121 has two surfaces parallel to each other. The substrate 121 has a through hole 1211. The plurality of pixel units disposed on the substrate 121. At least one of the pixel units comprises an active element 122, a reflective structure 123, and an insulation structure 124. The reflective structure 123 has a pixel electrode 1231 and a reflective layer 1232 disposed in an overlapped manner. The pixel electrode 1231 of the structure 123 is adjacent to the substrate 121, for example, the pixel electrode 1231 is disposed between the substrate 121 and the reflective layer 1232, and the pixel electrode 1231 is located on a side of the reflective layer 1232 facing the active element 122. The reflective layer 1232 is used to reflect light (such as L1 and L2 shown in FIG. 10). The insulation structure 124 is disposed around the active element 122. The insulation structure 124 has a conductive hole 1241. The active element 122 and the pixel electrode 1231 are electrically connected to each other through the conductive hole 1241 and the through hole 1211.

In this embodiment, as shown in FIG. 12, the active element 122 comprises a semiconductor layer (such as a-Si or IGZO) SC and a gate G. A source S and a drain D disposed on two opposite sides of the semiconductor layer SC. The source S and the drain D electrically connected to the semiconductor layer SC. The drain D and the pixel electrode 1231 are electrically connected through the conductive hole 1241 and the through hole 1211. The gate G and the semiconductor layer SC are provided within the projection range of the substrate 121, and the semiconductor layer SC is provided between the substrate 121 and the gate G. In this embodiment, a light-shielding member (not shown) may be further disposed under the semiconductor layer SC to make photoelectric signals more stable.

In this embodiment, as shown in FIG. 12, the insulation structure 124 comprises three inorganic material layers (e.g., as inorganic insulation layers) U121, U122, and U123. The inorganic material layer U121 is disposed on the substrate 121. The semiconductor layer SC, the source S, and the drain D disposed on the inorganic material layer U121. For example, the inorganic material layer U121 is partially used as an interlayered-insulation layer between the substrate 121 and each of the semiconductor layer SC, the source S, and the drain D. The conductive material of the drain D extends to the pixel electrode 1231, passing through the inorganic material layer U121 through the conductive hole 1241 and passing through the substrate 121 through the through hole 1211. The inorganic material layer U122 covers the semiconductor layer SC, the source S, and the drain D. A gate G is disposed on the inorganic material layer U122. For example, the inorganic material layer U122 is partially used as an interlayered-insulation layer between the gate G and each of the semiconductor layer SC, the source S, and the drain D. The inorganic material layer U123 covers the gate G, for example, the inorganic material layer U123 is used as a planarization layer.

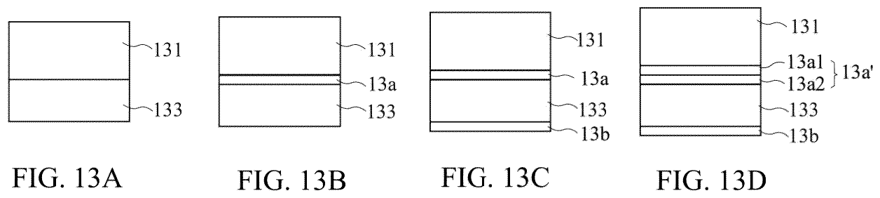

In some embodiments, for example, the substrate is located between the active element and the reflective structure, and the structure between the reflective structure and the substrate can be fine-tuned. For example, as shown in FIG. 13A, the substrate 131 can be provided with a reflective structure 133. In addition, as shown in FIG. 13B, a buffer layer 13a can be provided between the substrate 131 and the reflective structure 133. The buffer layer 13a can be made of a light-transmitting or light-impermeable material. For example, the buffer layer 13a comprises a conductive material. The conductive material comprises indium tin oxide (ITO), indium zinc oxide (IZO), molybdenum (Mo), aluminum (Al), titanium (Ti), molybdenum oxide (MoOₓ), aluminum oxide (AlOₓ), titanium oxide (TiOₓ), molybdenum aluminide (MoAl), or a combination thereof. Further, as shown in FIG. 13C, a buffer layer 13a is disposed between the substrate 131 and the reflective structure 133, and a protective layer 13b is disposed on one side of the reflective structure 133 away from the substrate 131, the protective layer 13b can be made of a high light-transmitting material, which can be a conductor or a non-conductor, such as a silicon-based compound, aluminum oxide (AlₓO_{y}), or a combination thereof, wherein the silicon-based compound comprises one of silicon oxide (SiOₓ), silicon nitride (SiNₓ) and silicon oxynitride (SiOₓN_{y}). Furthermore, as shown in FIG. 13D, a buffer layer 13a′ is disposed between the substrate 131 and the reflective structure 133. The protective layer 13b is disposed on one side of the reflective structure 133 away from the substrate 131, wherein the buffer layer 13a′ comprises at least two stacked buffer films (such as 13a1 and 13a2), and the buffer film can be made of the above-mentioned buffer layer material, which will not be further described.

For example, many implementations of bottom-emitting display panels are provided, such as the light transmission process not passing through many material layers around the active element, and the reflective structure being located on the side of the substrate facing toward or away from the display medium, are illustrated as follows.

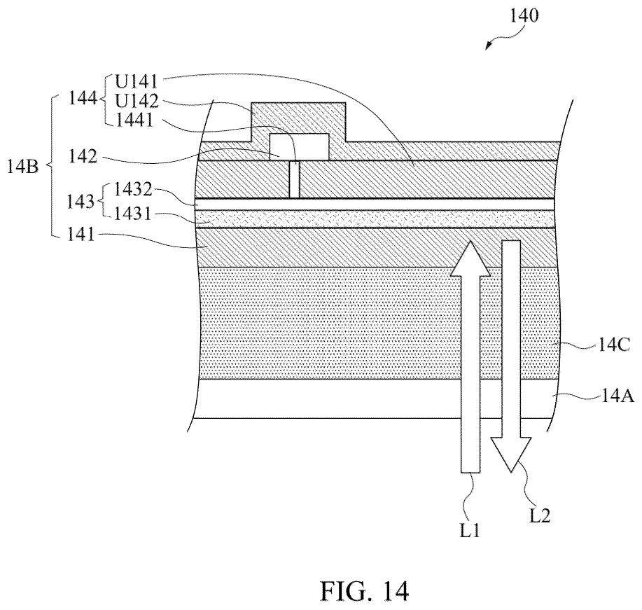

In some embodiments, as shown in FIG. 14, a display panel 140 is shown, comprising a color filter substrate 14A, an array substrate 14B, and a display medium layer 14C. The color filter substrate 14A and the array substrate 14B are disposed opposite to each other, and the display medium layer 14C (such as comprising liquid crystal material or electrophoretic material) is disposed between the color filter substrate 14A and the array substrate 14B. The array substrate 14B comprises a substrate 141 (such as a glass substrate) and a plurality of pixel units (FIG. 14 only shows a single pixel unit). The substrate 141 has two surfaces parallel to each other. A plurality of pixel units are disposed on the substrate 141. At least one of the pixel units comprises an active element 142, a reflective structure 143, and an insulation structure 144. The active element 142 comprises but is not limited to a top-gated or bottom-gated thin film transistor, which comprises a semiconductor material, such as amorphous silicon, low temperature polycrystalline silicon, or metal oxide. The reflective structure 143 has a reflective layer 1431 and a pixel electrode 1432 that are disposed in a stacked manner. The reflective layer 1431 of the reflective structure 143 is adjacent to one side of the substrate 141 (i.e., the reflective side, such as the side of the substrate 141 away from the color filter substrate 14A). For example, the reflective layer 1431 comprises a reflective material such as a metal material. The metal material comprises one of silver or aluminum. For process and yield considerations, one or more other elements (such as not more than 10 at %) may be doped to avoid affecting the original optical properties of the material. The reflective layer 1431 is disposed on the side of the substrate 141 facing the active element 142, e.g., the reflective layer 1431 has a thickness greater than 900 angstroms (Å), such as a thickness range of the reflective layer 1431 of 900 angstroms to 1200 angstroms, for reflecting light (as shown by L1 and L2). The reflective layer 1431 may further have surface microstructures, which is located on the side of the reflective layer 431 facing the substrate 141 (i.e., the light incident side) to assist in improving the light reflection effect. For example, the pixel electrode 1432 is a transparent conductive film, and the pixel electrode 1432 is disposed on a side of the reflective layer 1431 facing the active element 142 so that the pixel electrode 1432 is electrically connected to the active element 142. The insulation structure 144 is disposed around the active element 142, and the insulation structure 144 has at least one conductive hole 1441. The active element 142 and the pixel electrode 1432 are electrically connected through at least one conductive hole 1441.

In this embodiment, as shown in FIG. 14, the insulation structure 144 may include a plurality of stacked insulation material layers. The plurality of insulation material layers comprise inorganic materials, which comprise silicon oxide (SiO₂), silicon nitride (SiNₓ), silicon oxynitride (SiOₓN_{y}), or a combination thereof. For example, the insulation structure 144 has two inorganic material layers U141 and U142. The inorganic material layer (e.g., an insulation layer) U141 is disposed on the reflective structure 143. The active element 142 is disposed on the inorganic material layer U141. The inorganic material layer U141 has a conductive hole 1441 to electrically connect the active element 142 and the pixel electrode 1432. The inorganic material layer (e.g., an insulation layer) U142 covers the inorganic material layer U141 and the active element 142.

In this embodiment, the reflective structure has a reflective layer and a pixel electrode to reflect light and drive the display medium. The reflective structures need to be independently disposed, corresponding to the pixels. Namely, reflective structures corresponding to different pixels are not integrated. By the conductive hole between the reflective structure and the active element and the through hole of the substrate, the pixel electrode of each reflective structure can be used to control a respective pixel. In addition, the light reflection interface is located between the substrate and the reflective layer to have an excellent and stable reflectivity. Further, the active element is located on the side of the substrate away from the display medium. There is no need to make an organic planarization layer, so the quality of the reflective layer will naturally not be affected by a sputtering process, resulting in that the substrate has a better and more stable planarization effect, which makes it easier to control the gap between the liquid crystal cells, and the polarization effect of light can be stably controlled, so that the adaptability to change margin of the process becomes wider. Furthermore, because the active element is disposed on the other side of the light reflection path, the light is blocked by the reflective layer, which can avoid the light leakage phenomenon caused by the semiconductor photoelectric effect of the active element, and can have a lower picture update frequency, achieving a more power-saving function.

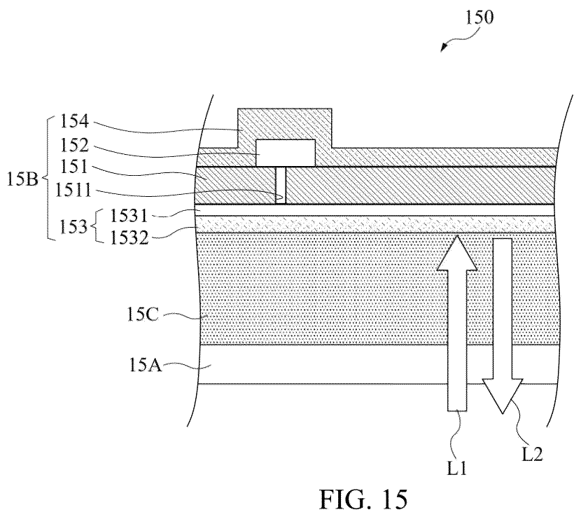

In some embodiments, as shown in FIG. 15, a display panel 150 is shown, comprising a color filter substrate 15A, an array substrate 15B, and a display medium layer 15C. The color filter substrate 15A and the array substrate 15B are disposed opposite to each other. The display medium layer 15C (such as comprising liquid crystal material and electrophoretic material) is disposed between the color filter substrate 15A and the array substrate 15B. The array substrate 15B comprises a substrate 151 (such as a glass substrate) and a plurality of pixel units (only a single pixel unit is shown in FIG. 15). The substrate 151 has two parallel surfaces. The plurality of pixel units disposed on the substrate 151. At least one of the pixel units comprises an active element 152, a reflective structure 153, and an insulation structure 154. The reflective structure 153 is disposed on a side of the substrate 151 away from the active element 152 (i.e., the light incident side/light reflecting side). For example, the reflective structure 153 has a pixel electrode 1531 and a reflective layer 1532 disposed in a stacked manner. The pixel electrode 1531 of the reflective structure 153 is adjacent to the substrate 151. The substrate 151 has a through hole 1511, through which the pixel electrode 1531 and the active element 152 are electrically connected. The reflective layer 1532 comprises a metal material. The metal material comprises one of silver or aluminum. However, for process and yield considerations, one or more other elements can be doped (such as no more than 10 at %) to avoid affecting the original optical properties of the material. The reflective layer 1532 is disposed on the side of the substrate 151 away from the active element 152. For example, the thickness of the reflective layer 1532 is greater than 900 angstroms (Å), such as the thickness of the reflective layer 1532 is in the range of 900 Å to 1200 Å, to reflect light (as shown by L1 and L2). The reflective layer 1532 may further have surface microstructures located on the side of the reflective layer 1532 away from the substrate 151 (i.e., the light incident side) to improve the light reflection effect. The insulation structure 154 is disposed around the active element 152. The insulation structure 154 may have at least one conductive hole (not shown). For example, at least one conductive hole is communicated with the through hole 1511 of the substrate 151, and the active element 152 and the pixel electrode 1531 are electrically connected through at least one conductive hole and the through hole 1511.

In this embodiment, as shown in FIG. 15, the insulation structure 154 may comprise at least one insulation material layer. The at least one insulation material layer comprises inorganic materials, comprising silicon oxide (SiO₂), silicon nitride (SiNₓ), silicon oxynitride (SiOₓN_{y}), or a combination thereof. For example, the active element 152 is disposed on the substrate 151, and the inorganic material layer included in the insulation structure 154 (e.g., as an inorganic insulation layer) covers the active element 152 and the substrate 151.

In this embodiment, the reflective structure has a reflective layer and a pixel electrode to provide functions of light reflection and driving the display medium. The reflective structures need to be independently disposed, corresponding to the pixels. Namely, the reflective structures corresponding to different pixels are not integrated. By the conductive hole between the reflective structure and the active element, the pixel electrode of each reflective structure can be used to control the corresponding pixel. In addition, the pixel electrode is closer to the display medium, and the electric field control effect is better. Further, the light does not need to pass through the substrate and then reflect to have a higher reflectivity. Furthermore, the active element is located on the side of the substrate away from the display medium. There is no need to make an organic planarization layer, so it will naturally not encounter the situation where a sputtering process affects the quality of the reflective layer. The substrate has a better and more stable planarization effect, which makes it easier to control the gap between the liquid crystal units. The polarization effect of light can be stably controlled, so that the adaptability to change margin of the process becomes wider. Moreover, because the active element is disposed on the other side of the light reflection path, the light is blocked by the reflective layer, which can avoid the light leakage phenomenon caused by the semiconductor photoelectric effect of the active element, and can have a lower picture update frequency, achieving a more power-saving function.

In the display panel and array substrate thereof of the above-mentioned embodiment of the present disclosure, a plurality of pixel units are disposed on a substrate, at least one of the plurality of pixel units comprises an active element, a reflective structure, and an insulation structure, the reflective structure has a reflective layer and a pixel electrode disposed in a stacked manner and is adjacent to one of the two surfaces of the substrate, the insulation structure is disposed around the active element and has at least one conductive hole, and the active element and the pixel electrode are electrically connected through the at least one conductive hole.

Thus, the above-mentioned embodiments of the present disclosure provide the reflective structure around the substrate, resulting in the reflective film being away from the organic film, so that the influence of the organic layer on the process can be avoided when the reflective layer is manufactured. A better and more stable vacuum environment can be provided to manufacture the reflective layer, thereby improving the quality of the reflective layer prepared by the vacuum sputtering equipment.

In addition, the bottom material of the reflective layer of the above embodiments of the present disclosure is based on a substrate, which has a better planarization effect. If the light reflection interface is located at the contact interface between the substrate and the reflective layer, it also has a smoother interface with more stability and less roughness. Therefore, the reflective layer is very suitable for directly forming on the substrate, which can solve the problem of the optical properties of the conventional reflective liquid crystal screen being affected by the organic layer and the circuit structure.

What is claimed is:

1. An array substrate, comprising:
a substrate having two surfaces parallel to each other; and
a plurality of pixel units disposed on the substrate, at least one of the plurality of pixel units comprising:
an active element;
a reflective structure having a reflective layer and a pixel electrode disposed in a stacked manner, wherein the reflective structure is disposed adjacent to one of the two surfaces of the substrate; and
an insulation structure disposed around the active element, wherein the insulation structure has at least one conductive hole, and the active element and the pixel electrode are electrically connected through the at least one conductive hole.

2. The array substrate as claimed in claim 1, wherein the pixel electrode is disposed on one side of the reflective layer facing the active element.

3. The array substrate as claimed in claim 1, wherein the active element comprises a semiconductor layer, a gate, a source, and a drain, wherein the semiconductor layer and the gate are stacked and insulated from each other, the source is electrically connected to the semiconductor layer, and the drain is electrically connected to the semiconductor layer and the pixel electrode.

4. The array substrate as claimed in claim 1, wherein the active element comprises a semiconductor layer, a gate, a source, and a drain, the semiconductor layer and the gate are stacked and insulated from each other, the semiconductor layer is electrically connected to the source and the drain, wherein the drain is electrically connected to the pixel electrode, and the drain and the reflective layer are arranged in a same layer.

5. The array substrate as claimed in claim 3, wherein the semiconductor layer comprises indium gallium zinc oxide (IGZO) or low-temperature polycrystalline silicon (LTPS).

6. The array substrate as claimed in claim 1, wherein the active element comprises a metal layer and an amorphous silicon (a-Si) semiconductor stacked and insulated from each other, the metal layer comprises a gate and the reflective layer insulated from each other, the gate and the amorphous silicon semiconductor overlap within a projection range of the substrate, a source and a drain are disposed on two opposite sides of the amorphous silicon semiconductor, the source and the drain are electrically connected to the amorphous silicon semiconductor, and the drain is electrically connected to the pixel electrode.

7. The array substrate as claimed in claim 1, wherein the reflective layer is disposed on one side of the substrate away from the active element, the substrate has a through hole, the through hole is in communication with the at least one conductive hole, and the active element and the pixel electrode are electrically connected through the at least one conductive hole and the through hole.

8. The array substrate, as claimed in claim 7, wherein the active element comprises a semiconductor layer and a gate, a source, and a drain are disposed on two opposite sides of the semiconductor layer, the source and the drain are electrically connected to the semiconductor layer, and the gate and the semiconductor layer are within the projection range of the substrate.

9. The array substrate as claimed in claim 1, wherein a buffer layer is disposed between the reflective structure and the substrate.

10. The array substrate as claimed in claim 9, wherein the buffer layer comprises at least two stacked buffer films.

11. The array substrate as claimed in claim 9, wherein a protective layer is disposed on one side of the reflective structure away from the substrate.

12. The array substrate as claimed in claim 11, wherein the protective layer comprises a light-transmitting material comprising a silicon-based compound, aluminum oxide (AlₓO_{y}), or a combination thereof, wherein the silicon-based compound comprises one of silicon oxide (SiOₓ), silicon nitride (SiNₓ), or silicon oxynitride (SiOₓN_{y}).

13. The array substrate as claimed in claim 9, wherein the buffer layer comprises a conductive material comprising indium tin oxide (ITO), indium zinc oxide (IZO), molybdenum (Mo), aluminum (Al), titanium (Ti), molybdenum oxide (MoOₓ), aluminum oxide (AlOₓ), titanium oxide (TiOₓ), molybdenum aluminide (MoAl), or a combination thereof.

14. The array substrate as claimed in claim 1, wherein the reflective layer comprises a metal material, and the metal material comprises one of silver or aluminum.

15. The array substrate as claimed in claim 1, wherein a thickness of the reflective layer is greater than 900 angstroms (Å).

16. The array substrate as claimed in claim 15, wherein the thickness of the reflective layer ranges from 900 angstroms to 1200 angstroms.

17. The array substrate as claimed in claim 1, wherein one side of the reflective layer has surface microstructures.

18. The array substrate, as claimed in claim 1, wherein the insulation structure comprises a plurality of insulation material layers disposed in a stacked manner, and the plurality of insulation material layers comprises inorganic materials comprising silicon oxide (SiO₂), silicon nitride (SiNₓ), silicon oxynitride (SiOₓN_{y}), or a combination thereof.

19. A display panel, comprising:
an array substrate;
a color filter substrate disposed opposite to the array substrate; and
a display medium layer disposed between the array substrate and the color filter substrate;
wherein the array substrate comprises a substrate and a plurality of pixel units, wherein the substrate has two surfaces parallel to each other, the plurality of pixel units are disposed on the substrate, and at least one of the plurality of pixel units comprises an active element, a reflective structure, and an insulation structure, the reflective structure has a reflective layer and a pixel electrode disposed in a stacked manner, wherein the reflective structure is disposed adjacent to one of the two surfaces of the substrate, the insulation structure is disposed around the active element, the insulation structure has at least one conductive hole, and the active element and the pixel electrode are electrically connected through the at least one conductive hole.

20. The display panel as claimed in claim 19, wherein the pixel electrode is disposed on one side of the substrate facing the display medium layer, the active element is disposed on one side of the substrate away from the display medium layer, the substrate has a through hole that is in communication with the at least one conductive hole, and the active element and the pixel electrode are electrically connected through the at least one conductive hole and the through hole.
